(19) United States
(12) Patent Application Publication
(10) Pub. No.: US 2026/0316927 A1
(43) Pub. Date: Oct. 15, 2026

(54) AIRCRAFT

(71) Applicant: Leonardo UK Ltd., London (GB)

(72) Inventors: Jeremy Graham, Merriott Somerset (GB); Simon Stacey, London (GB); Florent Dehaeze, London (GB)

(21) Appl. No.: 19/478,098

(22) PCT Filed: Mar. 21, 2024
(86) PCT No.: PCT/GB2024/050763

§ 371 Date: Oct. 23, 2025

(30) Foreign Application Priority Data
Apr. 26, 2023 (GB) 2306162.5

(51) Int. Cl. B64C 29/00

(52) U.S. Cl. CPC B64C 29/0033

(57) ABSTRACT

An aircraft includes a fuselage having first and second sides; a first rotor positioned at the first side of the aircraft and including a plurality of blades; and a second rotor positioned at the second side of the aircraft and including a plurality of blades. Each of the first and second rotor is moveable between a first position in which the rotor provides thrust in a generally vertical direction and a second position in which the rotor provides thrust in a generally horizontal direction. When the first and second rotors are in their respective first positions, the first and second rotor planes thereof are non-parallel, such that the first rotor plane does not intersect a portion of any of the blades of the second rotor and such that the second rotor plane does not intersect a portion of any of the blades of the first rotor.

### FIELD

Embodiments of the present invention relate to an aircraft, and in particular to a tiltrotor type aircraft.

### BACKGROUND

Many types of aircraft utilise at least one rotor to generate thrust. Some types aircraft may include rotors which are used principally for horizontal or forward flight, rotors which are used principally for vertical take-off and landing manoeuvrers, or which may be used for both types of flight condition.

For any type of aircraft having at least one rotor, damage to the rotor, particularly destructive failure, may inhibit the aircraft's ability to stay airborne. In particularly disastrous situations, such failure of a rotor may cause destructive failure to other parts of the aircraft which may result in failure or destruction of the craft and may put at risk the lives of the occupants of the aircraft and those in the vicinity of the aircraft. The present invention has been devised to address these issues.

### BRIEF DESCRIPTION OF THE INVENTION

According to a first aspect of the invention we provide an aircraft including:
a fuselage having first and second sides;
a first rotor positioned at the first side of the aircraft and including a plurality of blades, the first rotor being moveable between a first position in which the first rotor provides thrust in a generally vertical direction and a second position in which the first rotor provides thrust in a generally horizontal direction;
a second rotor positioned at the second side of the aircraft and including a plurality of blades, the second rotor being moveable between a first position in which the second rotor provides thrust in a generally vertical direction and a second position in which the second rotor provides thrust in a generally horizontal direction;
wherein the first rotor includes a first rotor plane positioned generally perpendicular to an axis of rotation of the first rotor, said first rotor plane being coincident with a portion of a blade of the first rotor;
wherein the second rotor includes a second rotor plane positioned generally perpendicular to an axis of rotation of the second rotor, said second rotor plane being coincident with a portion of a blade of the second rotor; and
wherein, when the first and second rotors are in their respective first positions, the first and second rotor planes are non-parallel, such that the first rotor plane does not intersect a portion of any of the blades of the second rotor and such that the second rotor plane does not intersect a portion of any of the blades of the first rotor.

The first rotor may include respective upper and lower rotor planes each positioned generally perpendicular to the axis of rotation of the first rotor, said upper rotor plane being coincident with an uppermost portion of a blade of the first rotor and said lower rotor plane being coincident with a lowermost portion of a blade of the first rotor; and wherein the second rotor may include respective upper and lower rotor planes each positioned generally perpendicular to the axis of rotation of the second rotor, said upper rotor plane being coincident with an uppermost portion of a blade of the second rotor and said lower rotor plane being coincident with a lowermost portion of a blade of the second rotor.

The upper rotor plane of the first rotor may not intersect a portion of any of the blades of the second rotor and such that the upper rotor plane of the second rotor does not intersect a portion of any of the blades of the first rotor.

The lower rotor plane of the first rotor may not intersect a portion of any of the blades of the second rotor and such that the lower rotor plane of the second rotor does not intersect a portion of any of the blades of the first rotor.

The first rotor plane may be coincident with the upper rotor plane or lower rotor plane of the first rotor, and wherein the second rotor plane may be coincident with the upper rotor plane or lower rotor plane of the second rotor.

When the first and second rotors are in their respective first positions, the first and second rotor planes may not intersect any part of the aircraft.

When the first and second rotors are in their respective second positions, the first and second rotor planes may be generally parallel.

The aircraft may further include a first movement device connected to the first rotor for moving the first rotor between its first position and second position and a second movement device connected to the second rotor for moving the second rotor between its first position and second position, wherein the first and second movement devices may be configured such that the first and second rotor planes are non-parallel when the first and second rotors are in their respective first positions and may gradually change to being generally parallel as the first and second rotors are moved from their respective first positions to their respective second positions.

Each of the first rotor and second rotor may be pivotably or rotatably moveable with respect to the fuselage.

The first and second rotors may be moveable to a third position, the third position being between the first position and second position.

Respective thrust vectors of the first and second rotors may be generally vertical when the first and second rotors are in their respective first positions; and/or respective thrust vectors of the first and second rotors may be generally horizontal when the first and second rotors are in their respective first positions; and/or respective thrust vectors of the first and second rotors may have a horizontal component and a vertical component when the first and second rotors are in their respective third positions.

The first and second rotors may be connected to a lifting surface.

The lifting surface may be an aerofoil, and optionally the lifting surface may includes at least one flight control surface.

The first and second rotors may pivotably or rotatably connected to the lifting surface.

The first rotor and second rotor may rotate about their respective axes of rotation in opposite directions.

The aircraft may be a tiltrotor craft.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a front view of an aircraft, with a first rotor and a second rotor in their respective first positions, in accordance with the present disclosure;

FIG. 2 is a front view of the aircraft of FIG. 1 with a first rotor and a second rotor in their respective second positions;

FIG. 3 is a side view of the aircraft of FIG. 1 with a first rotor and a second rotor in their respective first positions;

FIG. 4 is a side view of the aircraft of FIG. 1 with a first rotor and a second rotor in their respective third positions;

FIG. 5 is a side view of the aircraft of FIG. 1 with a first rotor and a second rotor in their respective second positions;

FIG. 6 is a plan view of the aircraft of FIG. 1 with a first rotor and a second rotor in their respective second positions; and

FIG. 7 is a plan view of the aircraft of FIG. 1 with a first rotor and a second rotor in their respective first positions.

### DETAILED DESCRIPTION OF THE DISCLOSURE

Referring to the Figures, there is shown an aircraft 10. The aircraft 10 includes a fuselage 100, a first rotor 20 and a second rotor 30. The aircraft 10 may include other features as described below. The aircraft 10 may be a tiltrotor type aircraft as known in the art.

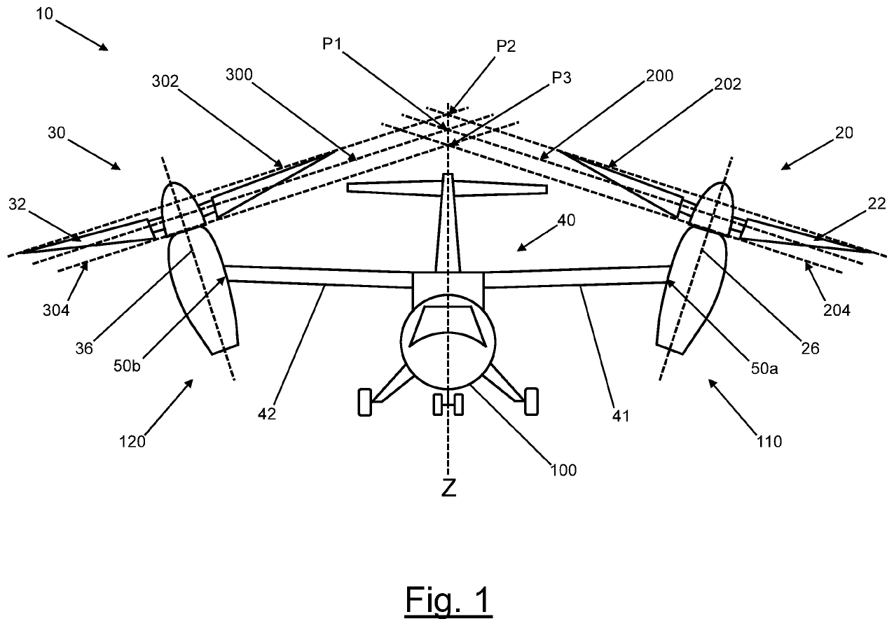

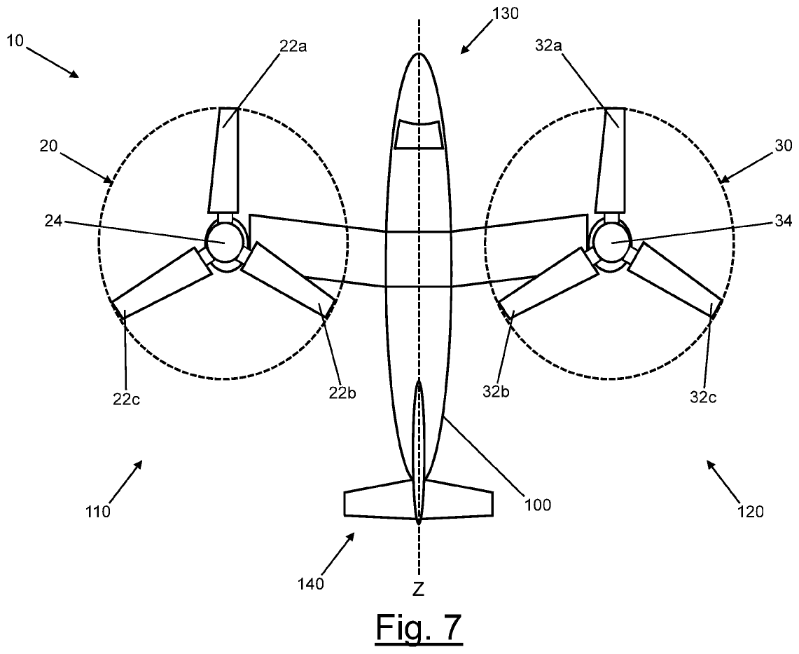

Referring to FIGS. 1 to 7, the fuselage 100 of the aircraft 10 may have a first side 110 and a second side 120. The first side 110 may be the starboard side and the second side 120 may be the port side. In addition, the fuselage 100 of the aircraft 10 may have a front end 130 and a rear end 140. Under flight conditions, the front end 130 of the fuselage 100 extends in a direction generally corresponding to the direction of travel of the aircraft 10. As also shown in FIG. 1, a vertical plane Z may be positioned in between the first side 110 and the second side 120 and may be positioned generally centrally with respect to the fuselage 100.

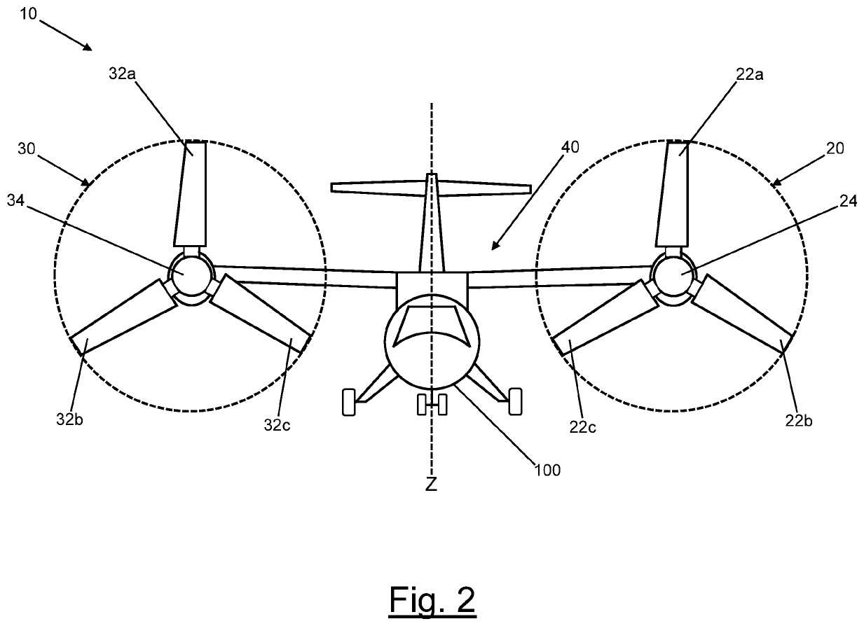

The aircraft 10 includes a first rotor 20 and a second rotor 30. The first rotor 20 may be positioned at the first side 110 of the aircraft 10 and may include a plurality of blades 22. In the embodiment shown in FIG. 2, the first rotor 20 may include three blades 22a, 22b, 22c. In other embodiments, the first rotor 20 may include two blades, or more than three blades. In embodiments, the first rotor 20 may also include a first rotor hub 24 which may serve to connect the plurality of blades 22 to a rotating mast (not shown) and a drive source (not shown). The drive source may include an electric motor, a combustion engine or any other appropriate driving means, and may be arranged as a hybrid drive system including any appropriate combination of driving means. When driven by an appropriate drive source, the first rotor 20 rotates about an axis of rotation 26 and generates thrust in a direction which is generally parallel to the axis of rotation 26.

The second rotor 30 may be positioned at the second side 120 of the aircraft 10 and may include a plurality of blades 32. In the embodiment shown in FIG. 2, the second rotor 30 may include three blades 32a, 32b, 32c. In other embodiments, the second rotor 30 may include two blades, or more than three blades. The second rotor 30 may also include other features such as a second rotor hub 34 which may serve to connect the plurality of blades 32 to a rotating mast (not shown) and a drive source (not shown). The drive source may include an electric motor, a combustion engine or any other appropriate driving means, and may be arranged as a hybrid drive system including any appropriate combination of driving means. When driven by an appropriate drive source, the second rotor 30 rotates about an axis of rotation 36 and generates thrust in a direction which is generally parallel to the axis of rotation 36. In the present embodiment of the aircraft 10, the first rotor 20 and the second rotor 30 may rotate about their respective axes of rotation in opposite rotational directions. For example, one of the first or second rotor 20, 30 may rotate in a clockwise direction, and the other of the first or second rotor 20, 30 may rotate in a counter-clockwise direction. In other words, the first rotor 20 and second rotor 30 may be contra-rotating rotors.

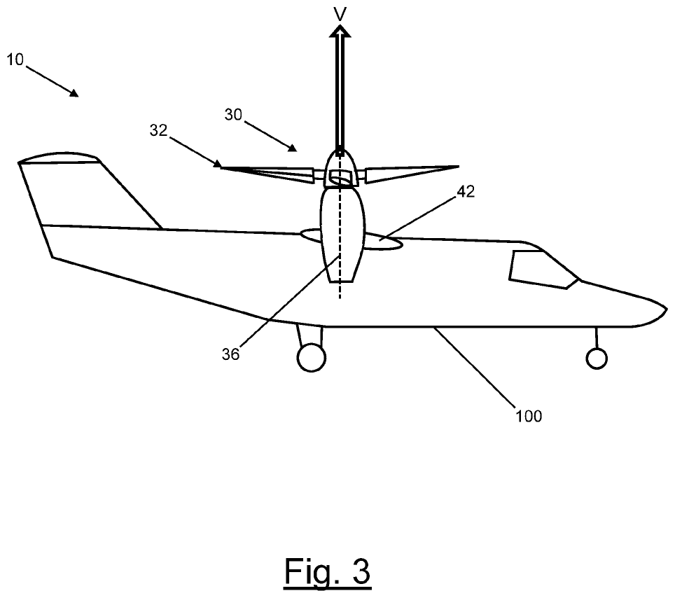

Each of the first rotor 20 and second rotor 30 may be moveable between a first position and a second position. When the first rotor 20 and second rotor 30 are in their respective first position, the axes of rotation 26, 36 of the first rotor 20 and second rotor 30 are oriented in a generally vertically direction, and the first rotor 20 and second rotor 30 each provide thrust in a generally vertical direction, as shown in FIG. 3 with respect to the second rotor 30. This first position enables the aircraft 10 to travel in a generally vertical direction, such as when the aircraft 10 is required to perform vertical take-off and landing operations.

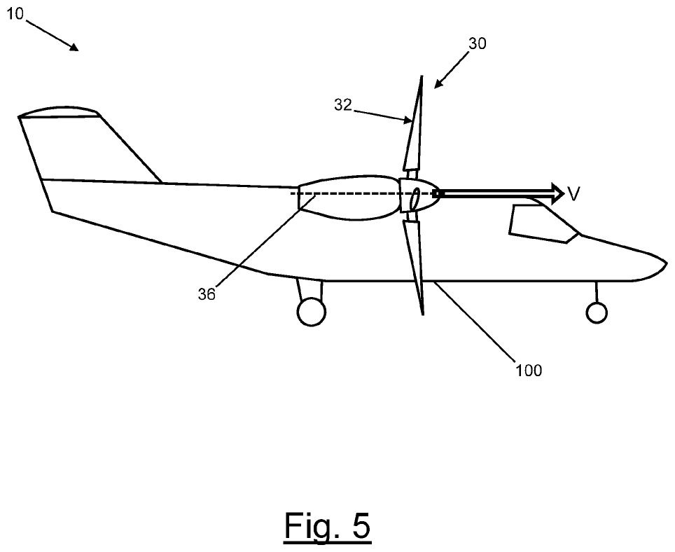

When the first rotor 20 and second rotor 30 are in their respective second position, the axes of rotation 26, 36 of the first rotor 20 and second rotor 30 are oriented in a generally horizontal direction, and the first rotor 20 and second rotor 30 each provide thrust in a generally horizontal direction, as shown in FIG. 5 with respect to the second rotor 30. This second position enables the aircraft 10 to travel in a generally horizontal direction for forward flight scenarios such as cruising, and as such this generally horizontal direction of the axes of rotation 26, 36 of the first rotor 20 and second rotor 30 is generally co-directional with the direction of travel of the aircraft 10.

The first rotor 20 and second rotor 30 may be moveable between their respective first positions and second positions relative to the fuselage 100. As a result, the fuselage 100 may be maintained in a generally fixed orientation whether the first rotor 20 and second rotor 30 are in the first position during vertical take-off, for example, or in the second position during forward flight. The movement of the first rotor 20 and second rotor 30 between their respective first positions and second positions may be accomplished by pivoting or rotational movement of the first rotor 20 and second rotor 30 relative to the fuselage 100, as described in more detail below.

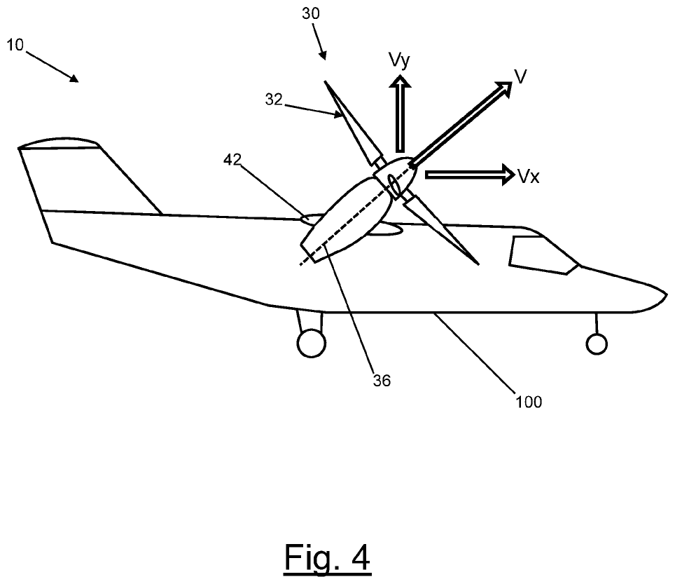

The first rotor 20 and second rotor 30 may also each be moveable to a respective third position relative to the fuselage 100, as shown in FIG. 4 with respect to the second rotor 30. As described above, when the first rotor 20 and second rotor 30 are in their respective first positions, the thrust generated by the rotors 20, 30 is aligned, directed or oriented in a generally vertical direction. As shown in FIG. 3, the direction of thrust provided by the first rotor 20 and second rotor 30 can be expressed as a thrust vector V, and when the first rotor 20 and second rotor 30 are in their respective first positions their respective thrust vector V may be aligned, directed or oriented in a generally vertical direction relative to the fuselage 100. As shown in FIG. 5, when the first rotor 20 and second rotor 30 are in their respective second positions their respective thrust vector V may be aligned, directed or oriented in a generally horizontal direction relative to the fuselage 100. As shown in FIG. 4, when the first rotor 20 and second rotor 30 are in their respective third positions the thrust vector V may be aligned, directed or oriented in a direction which is inclined relative to the generally horizontal and vertical directions. In other words, when the first rotor 20 and second rotor 30 are in their respective third positions the thrust vector V may comprise a generally horizontal thrust component Vx which may be aligned, directed or oriented in a generally horizontal direction relative to the fuselage 100 and generally corresponding to the direction of travel of the aircraft 10, and a generally vertical thrust component Vy which may be aligned, directed or oriented in a generally vertical direction relative to the fuselage 100. This third position may correspond to any position which may occur as a result of the first rotor 20 and second rotor 30 moving between the first position and the second position. This third position enables the aircraft 10 to change altitude during flight whilst also travelling in a generally horizontal direction for forward flight scenarios.

As described above, the first rotor 20 and second rotor 30 may be pivotably or rotatably moveable relative to the fuselage 100. Each of the first rotor 20 and second rotor 30 may be pivotably or rotatably connected to a part of the aircraft 10, such as a lifting surface 40 which forms part of the aircraft 10. For example, the first rotor 20 may be connected to a lifting surface 40 by a first movement device 50a and the second rotor 30 may be connected to the lifting surface 40 by a second movement device 50b. Each of the first movement device 50a and second movement device 50b may be provided as an electric motor or any appropriate actuator which may be operable to pivot or rotate the respective first or second rotor 20, 30 relative to the lifting surface 40. The first rotor 20 and second rotor 30 may be connected to the respective first and second movement devices 50a, 50b through other features of the aircraft 10 such as the mast and drive source or by mounting the first rotor 20 and second rotor 30 to respective nacelles 28, 38 which may support the respective first rotor 20 or second rotor 30 and serve to house drive components, electric motors and actuators and/or parts which cooperate with electric motors and actuators. The first and second movement devices 50a, 50b which provide the pivotable or rotatable connection between the first and second rotors 20, 30 and the lifting surface(s) 40 may be configured such that the movement of first rotor 20 and second rotor 30 between the first, second and third positions is generally synchronised, such that the rotors 20, 30 pivot or rotate relative to the fuselage 100 and lifting surface 40 at substantially the same speed, and that the first rotor 20 is always generally in the same position or orientation as the second rotor 30 relative to the fuselage 100 and lifting surface(s) 40.

As shown in the figures, the lifting surface 40 may include a first lifting surface 41 which is positioned on the first side 110 of the fuselage 100 and may be connected at a first end 41a to the fuselage 100 and connected at a second end 41b to the first rotor 20. The lifting surface 40 may also include a second lifting surface 42 which is positioned on the second side 120 of the fuselage 100, and may be connected at a first end 42a to the fuselage 100 and connected at a second end 42b to the second rotor 30. In other embodiments, the lifting surface 40 may be a shared or common lifting surface 40 which extends outwardly from a central point of the fuselage 100 and to which both the first rotor 20 and second rotor 30 may be connected to at opposite ends of the lifting surface 40, for example by the respective first and second movement devices 50a, 50b. In embodiments, the lifting surface 40, including the first lifting surface 41 and second lifting surface 42, may be an aerofoil of any appropriate profile. The lifting surface 40, including the first lifting surface 41 and second lifting surface 42, may be fixedly connected to the fuselage 100, such that they do not rotate or pivot as the first rotor 20 and second rotor 30 move between their respective first, second and third positions. In embodiments, the aircraft 10 may include additional lifting surfaces which do not support the first rotor 20 or second rotor 30 and which may be located on any appropriate part of the aircraft 10. In addition, the or each lifting surface 40, 41, 42 may include flight control surfaces such as flaps, ailerons and other forms of flight control surfaces known to the skilled person.

When the first rotor 20 and second rotor 30 are in the second position or third position, in addition to the thrust produced by the first rotor 20 and second rotor 30, the lifting surface(s) 40 also contribute to the overall lift force which keeps the aircraft 10 airborne during forward flight operations. In some embodiments, the first rotor 20 and second rotor 30 may be operated such that they provide a lower degree of thrust when in their respective second positions or third positions relative to when they are in their respective first positions.

As shown in FIG. 1, the first rotor 20 may include a first rotor plane 200 and the second rotor 30 may include a second rotor plane 300. The first rotor plane 200 may be positioned generally perpendicular to the axis of rotation 26 of the first rotor 20, and the first rotor plane 200 may be coincident with a portion of a blade of the plurality of blades 22 of the first rotor 20. In the example shown in FIG. 1, the first rotor plane 200 may be coincident with generally central portion of a blade of the plurality of blades 22. However, the first rotor plane 200 may be coincident with any portion of a blade of the plurality of blades 22, including an uppermost portion 23 or lowermost portion 25 as described below.

The second rotor plane 300 may be positioned generally perpendicular to the axis of rotation 36 of the second rotor 30, and the second rotor plane 300 may be coincident with a portion of a blade of the plurality of blades 32 of the second rotor 30. In the example shown in FIG. 1, the second rotor plane 300 may be coincident with generally central portion of a blade of the plurality of blades 32. However, the second rotor plane 300 may be coincident with any portion of a blade of the plurality of blades 32, including an uppermost portion 33 or lowermost portion 35 as described below.

When the first rotor 20 and the second rotor 30 are in their respective first positions, the first rotor plane 200 and second rotor plane 300 are oriented such that they are non-parallel, i.e., tilted with respect to the vertical plane Z positioned in between the first side 110 and second side 120 of the fuselage 100. As shown in FIG. 1, the first rotor plane 200 and second rotor plane 300 are oriented such that their axes or rotation 26, 36, and as such the direction of thrust provided by each of the first rotor 20 and second rotor 30, is tilted away from the fuselage in a generally upward, generally vertical direction. It should be understood that when oriented as such, any horizontal thrust component due to the tilt of the thrust vector V, and which is directed away from the fuselage 100, may be minimal or negligible in magnitude relative to the vertical thrust produced by the rotor 20, 30. As such, the first rotor plane 200 and second rotor plane 300 intersect with each other at an intersection point P1 which is above the fuselage 100 of the aircraft 10. In embodiments, the first rotor 20 and second rotor 30 may be oriented, or tilted, by a generally equal magnitude relative to the vertical plane Z, and may be located at a generally equal distance relative to the vertical plane Z, such that the first rotor 20 and second rotor 30 are positioned and oriented symmetrically about the vertical plane Z.

When the first rotor 20 and the second rotor 30 are in their respective first positions, the first rotor plane 200 and second rotor plane 300 are oriented to be non-parallel such that the first rotor plane 200 of the first rotor 20 does not intersect a portion of any of the blades of the plurality of blades 32 of the second rotor 30, and such that the second rotor plane 300 of the second rotor 30 does not intersect a portion of any of the blades of the plurality of blades 22 of the second rotor 22. In embodiments, the first rotor plane 200 and second rotor plane 300 are oriented to be non-parallel such that the first rotor plane 200 and second rotor plane 300 do not intersect any part of the aircraft 10, such as any part of the fuselage 100 and any part of the lifting surface(s) 40.

In embodiments, as shown in FIG. 1, the first rotor 20 may include a respective upper rotor plane 202 and a respective lower rotor plane 204. Each of the respective upper rotor plane 202 and lower rotor plane 204 may be positioned generally perpendicular to the axis of rotation 26 of the first rotor 20, and generally parallel with the first rotor plane 200. The upper rotor plane 202 may be coincident with an uppermost portion 23 of a blade, or all of the blades, of the plurality of blades 22, and the lower rotor plane 204 may be coincident with a lowermost portion 25 of a blade, or all of the blades, of the plurality of blades 22 of the first rotor 20. As such, the blade, or all of the blades, of the first rotor 20 may be positioned substantially between the upper rotor plane 202 and the lower rotor plane 204 of the first rotor 20.

The second rotor 30 may include a respective upper rotor plane 302 and a respective lower rotor plane 304. Each of the respective upper rotor plane 302 and lower rotor plane 304 may be positioned generally perpendicular to the axis of rotation 36 of the second rotor 30, and generally parallel with the second rotor plane 300. The upper rotor plane 302 may be coincident with an uppermost portion 33 of a blade, or all of the blades, of the plurality of blades 32, and the lower rotor plane 304 may be coincident with a lowermost portion 35 of a blade, or all of the blades, or the plurality of blades 32 of the second rotor 30. As such, the blade, or all of the blades, of the second rotor 30 may be positioned substantially between the upper rotor plane 302 and the lower rotor plane 304 of the second rotor 30.

In embodiments, when the first rotor 20 and the second rotor 30 are in their respective first positions, the first rotor 20 and the second rotor 30 may be oriented to be non-parallel such that the upper rotor plane 202 of the first rotor 20 does not intersect a portion of any of the blades of the plurality of blades 32 of the second rotor 30, and such that the upper rotor plane 304 of the second rotor 30 does not intersect a portion of any of the blades of the plurality of blades 22 of the first rotor 20. As such, the upper rotor plane 202 of the first rotor 20 and upper rotor plane 302 of the second rotor 30 may intersect with each other at an intersection point P2 which is above the fuselage 100 of the aircraft 10. Additionally, in some embodiments, the first rotor 20 and second rotor 30 may be oriented to be non-parallel such that the upper rotor planes 202, 302, of each of the first rotor 20 and second rotor 30 do not intersect any part of the aircraft 10, such as any part of the fuselage 100 and any part of the lifting surface(s) 40.

In other embodiments, when the first rotor 20 and the second rotor 30 are in their respective first positions, the first rotor 20 and the second rotor 30 may be oriented to be non-parallel such that the lower rotor plane 204 of the first rotor 20 does not intersect a portion of any of the blades of the plurality of blades 32 of the second rotor 30, and such that the lower rotor plane 304 of the second rotor 30 does not intersect a portion of any of the blades of the plurality of blades 22 of the first rotor 30. As such, the lower rotor plane 204 of the first rotor 20 and lower rotor plane 304 of the second rotor 30 may intersect with each other at an intersection point P3 which is above the fuselage 100 of the aircraft 10. In such embodiments, and as shown in FIG. 1, due to the lower rotor planes 204, 304 of the respective first and second rotors 20, 30 not intersecting with the plurality of blades 22, 32 of the other rotor 20, 30, any other rotor plane, such as the first rotor plane 200, second rotor plane 300, upper rotor plane 202 of the first rotor 20 and upper rotor plane 302 of the second rotor 30 will not intersect any part of any of the blades of the plurality of blades 22, 32 of the other rotor 20, 30. Additionally, in some embodiments, the first rotor 20 and second rotor 30 may be oriented to be non-parallel such that the lower rotor planes 204, 304, of each of the first rotor 20 and second rotor 30 do not intersect any part of the aircraft 10, such as any part of the fuselage 100 and any part of the lifting surface(s) 40. As described above, in such embodiments it is also the case that any other rotor plane, such as the first rotor plane 200, second rotor plane 300, upper rotor plane 202 of the first rotor 20 and upper rotor plane 302 of the second rotor 30 will not intersect any part of the aircraft 10, such as any part of the fuselage 100 and any part of the lifting surface(s) 40.

It should be understood that in embodiments, the first rotor plane 200 and second rotor plane 300 may be coincident with the respective upper rotor planes 202, 302 or lower rotor planes 204, 304 of the respective first and second rotors 20, 30. In embodiments, the first rotor plane 200 and second rotor plane 300 may be one of the respective upper rotor planes 202, 302 or may be one of respective lower rotor planes 204, 304 of the respective first and second rotors 20, 30

The non-parallel orientation of the first rotor 20 and second rotor 30, such that any of, or all of the first rotor plane 200, second rotor plane 300, upper rotor planes 202, 302 and lower rotor planes 204, 304 do not intersect a portion of any of the plurality of blades 22, 32 of the neighbouring rotor 20, 30 is particularly advantageous in the event of failure of one of the rotors 20, 30. For example, if one of the first rotor 20 or second rotor 30 is damaged to the extent that at least a part of at least one of the blades of the plurality of blades 22, 32 is shed or ejected from that rotor 20, 30, the non-parallel orientation of the first rotor 20 and second rotor 30 may reduce the risk, or may entirely eliminate the risk, of the shed part of the rotor 20, 30 colliding with a blade, or blades, of the plurality of blades 22, 32 of the other rotor 20, 30. Therefore, in a scenario where a rotor 20, 30 loses one blade and the thrust that can be provided by the rotor 20, 30 is diminished, the other uncompromised rotor 20, 30 can be controlled to provide a generally equally diminished thrust so that the aircraft 10 may maintain vertical flight until a safe landing can be performed. Vertical take-off and landing manoeuvres are a scenario where damage to a rotor 20, 30 can lead to catastrophic consequences as they are often performed in locations where other aircraft, vehicles and people are present. Reducing the risk of events whereby a damaged rotor 20, 30 can cause damage to the other rotor 20, 30 is therefore particularly desirable as it may reduce the volume of debris that may be shed from the rotors 20, 30, and may reduce the risk of an aircraft 10 crashing into a ground surface due to a complete loss of propulsion-both of which can cause the loss of life to not only the occupants of the aircraft 10, but those in the vicinity of the aircraft 10.

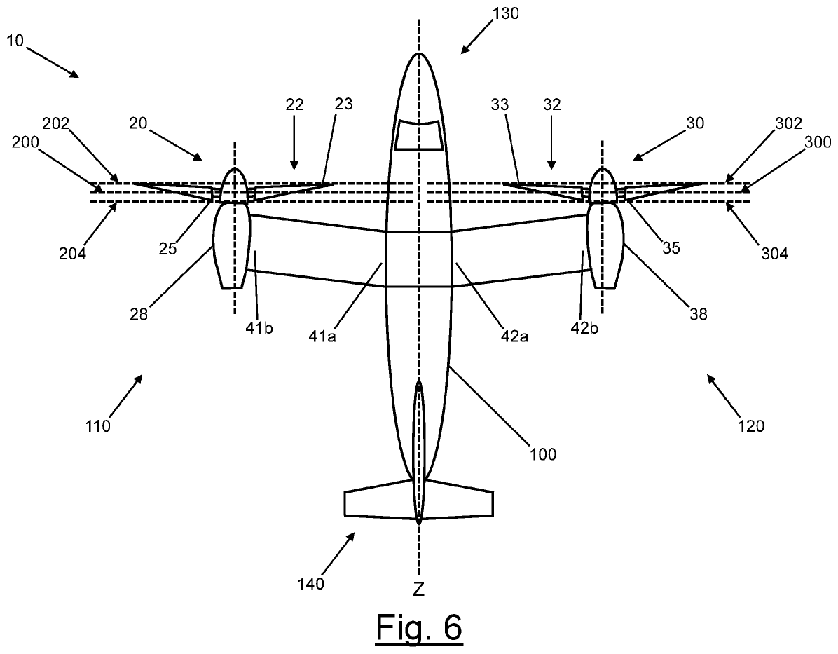

As shown in FIG. 6, whilst the first rotor 20 and second rotor 30 and associated planes 200, 202, 204, 300, 302, 304 may be non-parallel in their respective first positions, the first rotor 20 and second rotor 30 may be arranged such that any, or all of, the first rotor plane 200, second rotor plane 300, upper rotor planes 202, 302 and lower rotor planes 204, 304 are generally parallel when the first rotor 20 and second rotor 30 are in their respective second positions. When the aircraft 10 is in forward flight, such as when cruising, the consequences of a damaged blade being wholly or partly shed from one of the rotors 20, 30 and colliding with the other rotor 20, 30 may not be as severe compared to a vertical flight situation. For instance, if one or both rotors 20, 30 are damaged or otherwise compromised, depending on the cause of the damage the flight surface(s) 40 of the aircraft 10 will likely still be intact. The aircraft 10 may be guided to a safe landing by use of the lifting surface(s) 40 and any associated flight control surfaces which may be present. In addition, the aircraft 10 may be designed such that when the first rotor 20 and second rotor 30 are in their respective second positions, other parts of the aircraft 10, such as the fuselage 100, may act as a barrier between the first rotor 20 and the second rotor 30.

In embodiments, as the orientation of the first rotor 20 and second rotor 30 and associated rotor planes 200, 202, 204, 300, 302, 304 may change as the first rotor 20 and second rotor 30 move between their respective first, second and third positions, the first and second movement devices 50a, 50b which provide the pivotable or rotatable connection between the first rotor 20 and the second rotor 30 to the lifting surface 40, or respective lifting surfaces 41, 42 may be configured such that the associated rotor planes 200, 202, 204, 300, 302, 304 may gradually change from being non-parallel to being generally parallel as the first rotor 20 and second rotor 30 move from their respective first positions to their respective second positions. This may serve to reduce the complexity of the connection between the first rotor 20 and the second rotor to the lifting surface(s) 40, 41, 42, as secondary mechanisms may not be needed to tilt the thrust vector V of the first rotor 20 and second rotor 30 away from the fuselage 100 when in their respective first positions. In addition, when the first rotor 20 and second rotor 30 are in their respective third positions and said third position is such that the axes of rotation 26, 36 are still generally near vertical, the associated rotor planes 200, 202, 204, 300, 302, 304 may still be maintained in a generally non-parallel orientation.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An aircraft including:
a fuselage having first and second sides;
a first rotor positioned at the first side of the aircraft and including a plurality of blades, the first rotor being moveable between a first position in which the first rotor provides thrust in a generally vertical direction and a second position in which the first rotor provides thrust in a generally horizontal direction;
a second rotor positioned at the second side of the aircraft and including a plurality of blades, the second rotor being moveable between a first position in which the second rotor provides thrust in a generally vertical direction and a second position in which the second rotor provides thrust in a generally horizontal direction;
wherein the first rotor includes a first rotor plane positioned generally perpendicular to an axis of rotation of the first rotor, said first rotor plane being coincident with a portion of a blade of the first rotor;
wherein the second rotor includes a second rotor plane positioned generally perpendicular to an axis of rotation of the second rotor, said second rotor plane being coincident with a portion of a blade of the second rotor; and
wherein, when the first and second rotors are in their respective first positions, the first and second rotor planes are non-parallel, such that the first rotor plane does not intersect a portion of any of the blades of the second rotor and such that the second rotor plane does not intersect a portion of any of the blades of the first rotor.

2. An aircraft according to claim 1 wherein:
the first rotor includes respective upper and lower rotor planes each positioned generally perpendicular to the axis of rotation of the first rotor, said upper rotor plane being coincident with an uppermost portion of a blade of the first rotor and said lower rotor plane being coincident with a lowermost portion of a blade of the first rotor; and
wherein the second rotor includes respective upper and lower rotor planes each positioned generally perpendicular to the axis of rotation of the second rotor, said upper rotor plane being coincident with an uppermost portion of a blade of the second rotor and said lower rotor plane being coincident with a lowermost portion of a blade of the second rotor.

3. An aircraft according to claim 2 wherein the upper rotor plane of the first rotor does not intersect a portion of any of the blades of the second rotor and such that the upper rotor plane of the second rotor does not intersect a portion of any of the blades of the first rotor.

4. An aircraft according to claim 2, wherein the lower rotor plane of the first rotor does not intersect a portion of any of the blades of the second rotor and such that the lower rotor plane of the second rotor does not intersect a portion of any of the blades of the first rotor.

5. An aircraft according to claim 2, wherein the first rotor plane is coincident with the upper rotor plane or lower rotor plane of the first rotor, and wherein the second rotor plane is coincident with the upper rotor plane or lower rotor plane of the second rotor.

6. An aircraft according to claim 1, wherein, when the first and second rotors are in their respective first positions, the first and second rotor planes do not intersect any part of the aircraft.

7. An aircraft according to claim 1, wherein, when the first and second rotors are in their respective second positions, the first and second rotor planes are generally parallel.

8. An aircraft according to claim 7 further including a first movement device connected to the first rotor for moving the first rotor between its first position and second position and a second movement device connected to the second rotor for moving the second rotor between its first position and second position, wherein the first and second movement devices are configured such that the first and second rotor planes are non-parallel when the first and second rotors are in their respective first positions and gradually change to being generally parallel as the first and second rotors are moved from their respective first positions to their respective second positions.

9. An aircraft according to claim 1, wherein each of the first rotor and second rotor are pivotably or rotatably moveable with respect to the fuselage.

10. An aircraft according to claim 1, wherein the first and second rotors are moveable to a third position, the third position being between the first position and second position.

11. An aircraft according to claim 10 wherein: respective thrust vectors of the first and second rotors are generally vertical when the first and second rotors are in their respective first positions; and/or wherein respective thrust vectors of the first and second rotors are generally horizontal when the first and second rotors are in their respective first positions; and/or wherein respective thrust vectors of the first and second rotors have a horizontal component and a vertical component when the first and second rotors are in their respective third positions.

12. An aircraft according to claim 1, wherein the first and second rotors are connected to a lifting surface.

13. An aircraft according to claim 12 wherein the lifting surface is an aerofoil, and optionally wherein the lifting surface includes at least one flight control surface.

14. An aircraft according to claim 12, wherein the first and second rotors are pivotably or rotatably connected to the lifting surface.

15. An aircraft according to claim 1, wherein the first rotor and second rotor rotate about their respective axes of rotation in opposite directions.

16. An aircraft according to claim 1, wherein the aircraft is a tiltrotor craft.

17. The aircraft according to claim 3,
wherein the lower rotor plane of the first rotor does not intersect a portion of any of the blades of the second rotor and such that the lower rotor plane of the second rotor does not intersect a portion of any of the blades of the first rotor;
wherein the first rotor plane is coincident with the upper rotor plane or lower rotor plane of the first rotor, and wherein the second rotor plane is coincident with the upper rotor plane or lower rotor plane of the second rotor;
wherein, when the first and second rotors are in their respective first positions, the first and second rotor planes do not intersect any part of the aircraft;
wherein, when the first and second rotors are in their respective second positions, the first and second rotor planes are generally parallel;
the aircraft further including a first movement device connected to the first rotor for moving the first rotor between its first position and second position and a second movement device connected to the second rotor for moving the second rotor between its first position and second position, wherein the first and second movement devices are configured such that the first and second rotor planes are non-parallel when the first and second rotors are in their respective first positions and gradually change to being generally parallel as the first and second rotors are moved from their respective first positions to their respective second positions;
wherein each of the first rotor and second rotor are pivotably or rotatably moveable with respect to the fuselage;
wherein the first and second rotors are moveable to a third position, the third position being between the first position and second position;
wherein: respective thrust vectors of the first and second rotors are generally vertical when the first and second rotors are in their respective first positions; and/or wherein respective thrust vectors of the first and second rotors are generally horizontal when the first and second rotors are in their respective first positions; and/or wherein respective thrust vectors of the first and second rotors have a horizontal component and a vertical component when the first and second rotors are in their respective third positions;
wherein the first and second rotors are connected to a lifting surface;
wherein the lifting surface is an aerofoil, and optionally wherein the lifting surface includes at least one flight control surface;
wherein the first and second rotors are pivotably or rotatably connected to the lifting surface;
wherein the first rotor and second rotor rotate about their respective axes of rotation in opposite directions; and
wherein the aircraft is a tiltrotor craft.
